(19) United States
(12) Patent Application Publication
(10) Pub. No.: US 2011/0010808 A1
(43) Pub. Date: Jan. 13, 2011

(54) PROTECTED METALLIC TIP OR METALLIZED SCANNING PROBE MICROSCOPY TIP FOR OPTICAL APPLICATIONS

(75) Inventors: Carlos A. Barrios, Akron, OH (US); Mark D. Foster, Stow, OH (US); Alexei Sokolov, Copley, OH (US); Audrey Malkovskiy, Akron, OH (US); Ryan Hartschuh, Copley, OH (US)

Correspondence Address: Joseph J. Crimaldi;Roetzel & Andress, 222 S. Main St., Akron, OH, 44308, US

(73) Assignee: THE UNIVERSITY OF AKRON, Akron, OH (US)

(21) Appl. No.: 12/809,720

(22) PCT Filed: Dec. 18, 2008
(86) PCT No.: PCT/US08/13848

§ 371 Date: Sep. 28, 2010

Related U.S. Application Data
(60) Provisional application No. 61/008,759, filed on Dec. 21, 2007.

(51) Int. Cl. G01Q 60/22; G01Q 70/14

(52) U.S. Cl. 850/32; 850/59

(57) ABSTRACT

The present invention generally relates to a protected metallic or metallized scanning probe microscopy tip for apertureless near-field optical applications which comprise a metallic tip or a metallic structure covering a scanning probe microscopy tip, protected by an ultrathin dielectric layer. In one embodiment, the protective layer is comprised of SiOₓ, AI₂O₃, or any other hard ultrathin dielectric layer that extends the lifetime of the tip by providing mechanical, chemical, and thermal protection to the entire structure.

### FIELD OF THE INVENTION

The present invention generally relates to a protected metallic or metallized scanning probe microscopy tip for apertureless near-field optical applications which comprise a metallic tip or a metallic structure covering a scanning probe microscopy tip, protected by an ultrathin dielectric layer. In one embodiment, the protective layer is comprised of SiOₓ, Al₂O₃, or any other hard ultrathin dielectric layer that extends the lifetime of the tip by providing mechanical, chemical, and thermal protection to the entire structure.

### BACKGROUND OF THE INVENTION

The present invention relates to a protected metallic tip or a metallized scanning probe microscopy (SPM) tip for apertureless near-field optical applications providing improved wear resistance, corrosion resistance, abrasion resistance and extended service life. An ultrathin protective layer provides the improved wear resistance, corrosion resistance, abrasion resistance and the extended service life.

Metallic tips or metallized SPM tips for optical applications involve the use of sharp metal structures or thin metallic structures which cover the SPM tips. Abrasive friction forces between the surface to be analyzed and tips for optical applications, commonly made or covered by gold (Au), silver (Ag), platinum (Pt), or copper (Cu), are the main culprits for the occurrence of wear during scanning. Furthermore, metallic or metallized tips may deteriorate irreversibly under exposure to light or normal environmental conditions. An optically invisible protective coating introduces wear resistance to the metallic structure while minimizing chemical reactions responsible for degradation. Gold (Au), silver (Ag), platinum (Pt), and copper (Cu) are of special interest for use in apertureless near-field optical applications.

Atmospheric corrosion of silver, generally known as tarnishing, is a form of degradation in which atmospheric sulfur (e.g., hydrogen sulfide (HS), carbonyl sulfide (COH), etc.) reacts with silver to form silver sulfide. Silver degrades upon exposure to various gaseous sulfur-containing compounds in the atmosphere with hydrogen sulfide (H₂S) and carbonyl sulfide among the two most important corrodents. For apertureless optics, the surface “plasmon resonance” of the silver structure on the tip is key. The surface plasmon resonance is a collective oscillation of electrons at the surface of features in the metal structure. Thus, the structured metal film that can exhibit a plasmon resonance is known as a “plasmonic structure”. The surface plasmon resonance is destroyed upon sulfidization of the silver structure and/or wearing of the silver structure. SPM tips with silver structures of approximately 50 nm nominal thickness no longer provide plasmon enhancement after about 24 hours of continuous exposure to 2 mW irradiation in air in an apparatus designed for measuring tip-enhanced Raman spectroscopy or measuring scanning Raman imaging of a surface with high lateral resolution.

Coated probes for SPM (non-optical) applications are known. For example, Korean Patent 2006-103299, teaches an atomic microscope probe coated with semi-metal chromium oxide to increase the strength of the probe. An atomic force microscope probe coated with semi-metal chromium oxide is manufactured by coating a semi-metal chromium oxide thin film by the chemical vapor deposition (CVD) method. In the CVD method of the patent, the CVD reactor included a two-zone electric furnace along with a quartz tube. The probe coated with chromium oxide can then be used to measure the surface topography, the conductivity, and the magnetism of a sample.

Diamond coated AFM tips (non-optical) are also known and used. The diamond coating is an approximately 50 to 100 nm thick coating of polycrystalline diamond on the tip-side of the cantilever, leading to an unsurpassed hardness of the tip. The coating is highly doped with boron. This leads to a macroscopic resistivity of 0.003 to 0.005 Ohm*cm.

### SUMMARY OF THE INVENTION

The present invention generally relates to a protected metallic or metallized scanning probe microscopy tip for apertureless near-field optical applications which comprise a metallic tip or a metallic structure covering a scanning probe microscopy tip, protected by an ultrathin dielectric layer. In one embodiment, the protective layer is comprised of SiOₓ, Al₂O₃, or any other hard ultrathin dielectric layer that extends the lifetime of the tip by providing mechanical, chemical, and thermal protection to the entire structure.

In one embodiment the present invention relates to a protected metallic tip for apertureless near-field optical applications comprising: a metallic tip, and a protective coating covering the metallic tip.

In yet another embodiment, the present invention relates to a protected metallized scanning probe microscopy (SPM) tip for apertureless near-field optical applications comprising: an SPM tip, a metal structure covering the surface of the SPM tip, and a protective coating covering the metal structure.

### BRIEF DESCRIPTION OF THE DRAWINGS

FIG. 1a is a schematic illustration of a protected metallized tip in contact with a surface and showing a metal structure and an ultrathin protective coating;

FIG. 1b is a schematic of the different layers of a protected plasmonic structure on a tip and the protective coating between the plasmonic structure and the surrounding laboratory environment;

FIG. 1c is a schematic of a tip working in contact mode configuration;

FIG. 1d is a schematic of a tip working in tapping mode configuration;

FIG. 1e is a schematic of a tip working in non-contact mode configuration;

FIG. 2 is a transmission electron image of a metallized and protected SPM tip;

FIG. 3 is a graph comparing tip enhanced Raman spectra from an inorganic film made of cadmium sulfate (CdS) sample obtained with a freshly-prepared, protected, metallized tip versus those obtained with an unprotected, metallized tip from the same sample;

FIG. 4 provides Raman spectra with the tip withdrawn from the sample and with the tip in contact with the sample for an (a) unprotected tip and a (b) protected tip;

FIG. 5 provides a comparison of tip enhanced Raman spectra obtained from a CdS film on an aluminum mirror with a protected, metallized tip and an unprotected, metallized tip;

FIG. 6 provides a comparison of the change in contrast with time for an unprotected tip (open circles) with a protected tip (filled squares) where open symbols correspond to tips stored under dry conditions and filled markers correspond to tips stored under normal ambient conditions for the time of the experiment; and

FIG. 7 provides transmission electron microscopy (TEM) images of an unprotected tip after use, and a protected tip after use.

### DETAILED DESCRIPTION OF THE INVENTION

The present invention generally relates to a protected metallic or metallized scanning probe microscopy tip for apertureless near-field optical applications which comprise a metallic tip or a metallic structure covering a scanning probe microscopy tip, protected by an ultrathin dielectric layer. In one embodiment, the protective layer is comprised of SiOₓ, Al₂O₃, or any other hard ultrathin dielectric layer that extends the lifetime of the tip by providing mechanical, chemical, and thermal protection to the entire structure.

The invention is a protected metallic tip or metallized SPM tip with improved wear resistance and extended service lifetime. Protection by a dielectric ultrathin coating, including, but not limited to SiOₓ or Al₂O₃ and fabricated by physical vapor deposition (PVD), is presented. A dielectric material is a material that can sustain an electric field with minimal current flow. In this case, certain examples include materials that are optically inactive as well. PVD is a low temperature vacuum coating process commonly used to apply thin metallic coatings.

One advantage of the present invention is the creation of a protected, mechanical, chemical, and thermal degradation resistant, highly enhancing plasmonic structure on a metallic tip or an SPM tip having a metal structure along with an ultrathin protective coating. One advance, made via materials design, is the achievement of corrosion protection and wear resistance without compromising optical signal enhancement. This advance has been detailed by measurements on thin films of a conductive polymer blend of poly(3,4-thylenedioxythiophene) and poly(styrenesulfonate) (PEDOT/PSS) and an inorganic film made of cadmium sulfate (CdS).

One objective of the present invention is to provide a protected metallic tip or a metallized SPM tip capable of accurately measuring surface topography while enhancing the electric field of light for apertureless near-field optics. To achieve this, a metallic tip or an SPM tip having a metal structure responsible for enhancing the electric field of light, comprising a thin metal structure, coated with an ultrathin layer improving the wear resistance of the metallic structure and reducing deterioration by environmental agents and heating is provided.

The present invention is directed to a protected metallic tip or a metallized scanning probe microscopy (SPM) tip for apertureless near-field optical applications that includes a metallic tip or an SPM tip, a metal structure covering the surface of the tip, and a protective coating covering the metal structure. The tip is a metallic tip, or a contact mode, an intermittent contact mode or a non-contact mode SPM tip. The metal structure includes a material exhibiting plasmon resonance. Plasmon resonance is a collective oscillation of the electrons at the surface of features in a metal structure. The structured metal film is also known as a “plasmonic structure”. The metal structure comprises gold (Au), silver (Ag), platinum (Pt), copper (Cu), any other metal or combinations thereof. The tip enhances the electric field of light for apertureless near-field optics. In apertureless near field optics a probe with sub-wavelength size introduces a short range perturbation to an optical field. If the probe is covered with a plasmonic structure, the perturbation enhances the optical signal from material located within a few nanometers of the apex of the tip, and the strongly enhanced optical signal can be used to construct a chemical image. Such a signal enhancement can be obtained for spectroscopies including, but not limited to, Raman, infrared, fluorescence, photoluminensce, sum frequency generation, two photon or photoemission spectroscopies.

The metal structure is protected by a dielectric ultrathin film. The protective coating is made of a dielectric material such as, but not limited to, silica, alumina, diamond like carbon coating, a highly crosslinked polymer film or any combination of two or more thereof. The protective coating can be between 0.1 and 20 nanometers thick or in another embodiment between 1.0 and 5.0 nanometers thick. The protective coating itself possesses a Vickers hardness value higher than the Vickers hardness values for gold, silver, and similar metals. In one embodiment the alumina protective layer having a hardness at least ten times more than the metal structure. In another embodiment the ultra-thin, highly crosslinked polymer film possessing a Vickers hardness at least 100% higher than the Vickers Hardness of the metal layers.

This results in a protected tip that shows improved wear resistance and extended service life, while possessing optical properties about the same or better than those of an unprotected tip. In some cases, the field enhancement produced by the protected tips is slightly decreased by the protective layer, as in the case of a protective layer of SiOₓ, or is slightly increased, as in the case of Al₂O₃. In either case, the protected tip can be successfully used to obtain chemical images. Additional dielectric materials include various silicas, aluminas, diamond like carbon coatings, polymer films, highly crosslinked polymer films and combinations of two or more of the same. The tip of the present invention allows one to obtain topographical images of surfaces with a resolution of about 20 nm using a commercial AFM instrument coupled with a spectrometer.

The invention presented here incorporates a beneficial approach for improving wear resistance and extending the lifetimes of metallic tips or metallized SPM tips used in high resolution optical spectroscopies for materials characterization or high sensitivity detection schemes. This is achieved by using an ultrathin dielectric coating capable of providing structural support to the metal structure and slowing the metal degradation by environmental agents and heating, while minimizing unfavorable influences on the optical response of the structures. This enhanced durability is novel for metallic/metallized tips used in apertureless near-field optics applications.

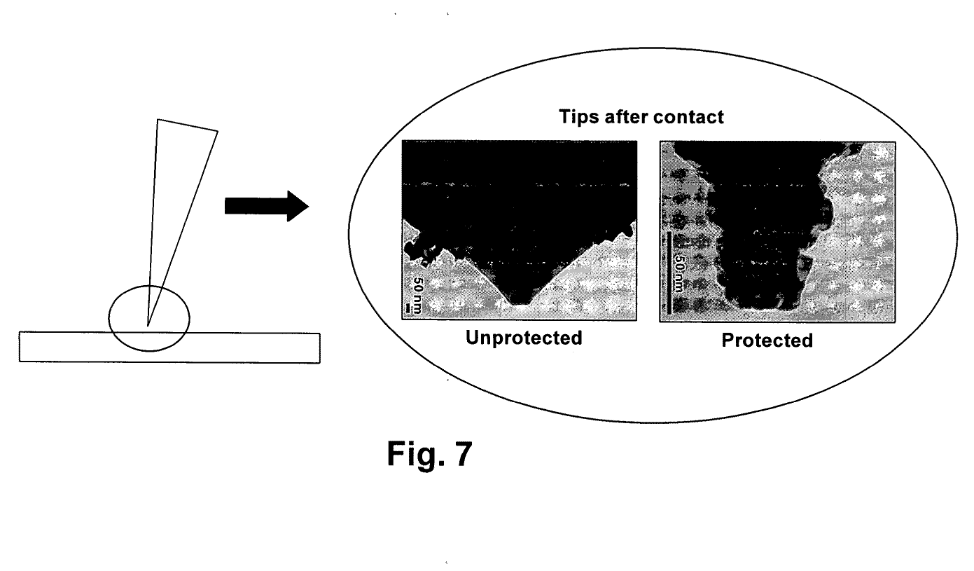

The metallic structure of an alumina-protected tip remains unchanged for 40 days when used an average of one hour per day, while the metallic structure of an unprotected tip wears out within a period of 5 to 10 days under similar conditions of use. The metallic structure of unprotected tips can be completely removed from the apex during scanning. In some cases, the metal structure is absent in an area that extends to approximately 200 nanometers from the tip apex in the direction of the tip base (FIG. 7). A tip without metal at the apex does not provide any signal enhancement. Similar degrees of damage and/or deformation were observed for other unprotected tips wherein wear was the main degradation mechanism. In another comparison, an alumina-protected tip was found to have negligible signal enhancement loss for a period of over 40 days while unprotected tips lost 50% of their initial signal enhancement after only 20 days of use, and completely lost their signal enhancement after 40 days. In the case of silver plasmonic structures, the unprotected tips lost the signal enhancement after 40 days even though they had not been used due to chemical degradation of the metal (this is one problem encountered using silver, i.e. tarnishing). In some cases, this loss was as quick as 5 days when the metal structure was fractured.

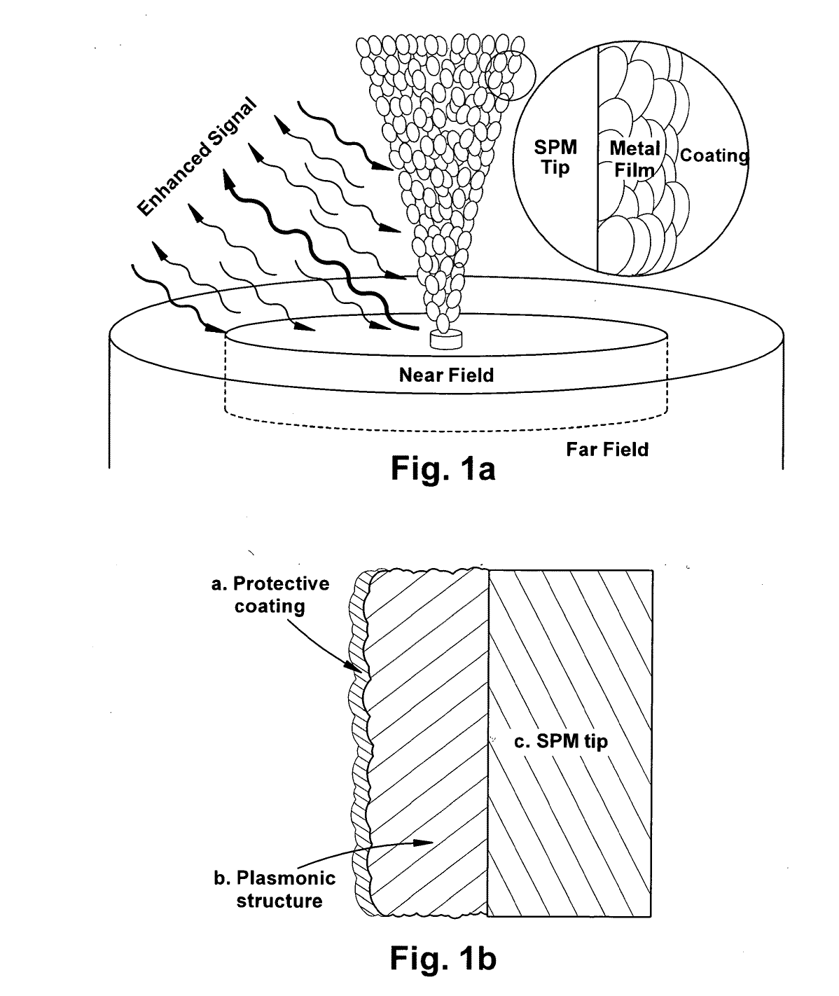

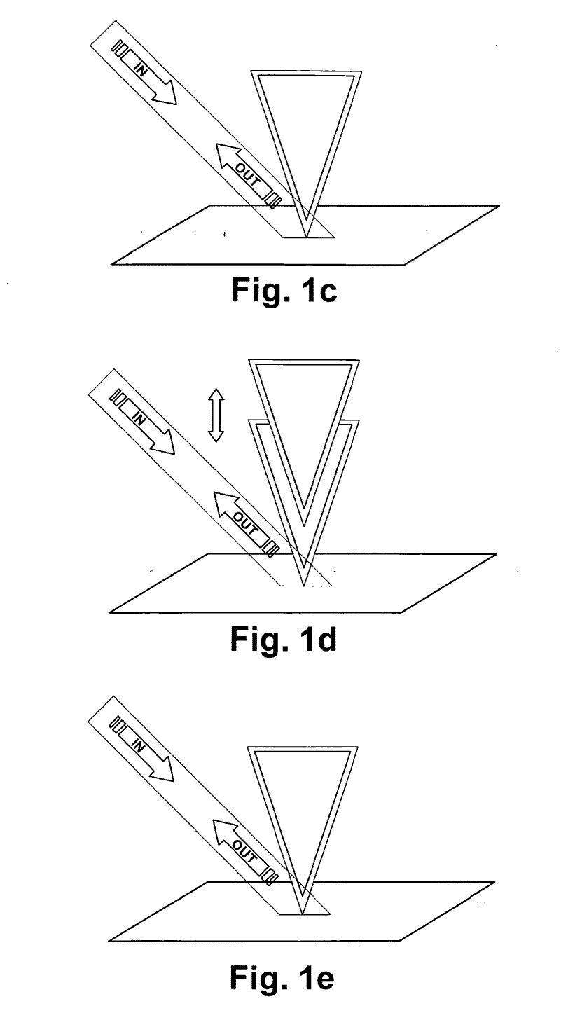

The research for the present invention investigated the protection provided by a dielectric layer fabricated by physical vapor deposition (PVD). The multilayer plasmonic structure of the present invention is shown schematically in FIG. 1a. FIG. 1a details a metallized SPM tip protected by an ultrathin dielectric layer illuminated from the side and in contact with a surface. The figure shows a side-illumination configuration, but the tips are equally adaptable to top- or bottom-illumination.

FIG. 1b shows details of the layers present at the surface of the tip. FIG. 1b is a schematic of the different layers composing a protected plasmonic structure on a tip with the plasmonic structure adjacent to the SPM tip or metallic tip, and the protective coating between the plasmonic structure and the surrounding laboratory environment, whether it be air, another gas, vacuum, or a liquid. A protected tip can be made using various materials for the protective coating, including, but not limited to SiOₓ or Al₂O₃. The extraordinary enhancement of an optical spectroscopy signal in a very small region immediately beneath the tip results from plasmon resonance in the surface of the novel metal layer that has nanoscale roughness or “bumps”.

Chemical imaging can be obtained with a tip scanning in contact mode (FIG. 1c), intermittent contact mode (FIG. 1d) or non-contact mode (FIG. 1e). FIG. 1c is a schematic of a tip working in contact mode configuration for chemical imaging using apertureless near-field optics under side-illumination showing the light beam illuminating the tip continuously at the point of contact between the tip and sample while the measured signal is collected using the same optics used to bring the laser beam to the surface of the sample (other illumination geometries are possible, including top-illumination and bottom-illumination and the protective coating is effective no matter what illumination geometry is used). FIG. 1d is a schematic of a tip working in tapping mode configuration for chemical imaging using apertureless near-field optics where the tip moves in an oscillation motion with respect to the sample surface and axis of the laser beam. FIG. 1e is a schematic of a tip working in non-contact mode configuration for chemical imaging using apertureless near-field optics (note that the tip is always slightly away from the surface and stays at approximately the same distance from the surface).

The improvement realized via materials design, is achieving corrosion protection and improved wear resistance without compromising optical properties. This advance has been proved by measurements on thin films of a conductive polymer blend (PEDOT/PSS) and an inorganic material (CdS). The results were similar for the two films, though the intensity of the signal was higher for the CdS layer.

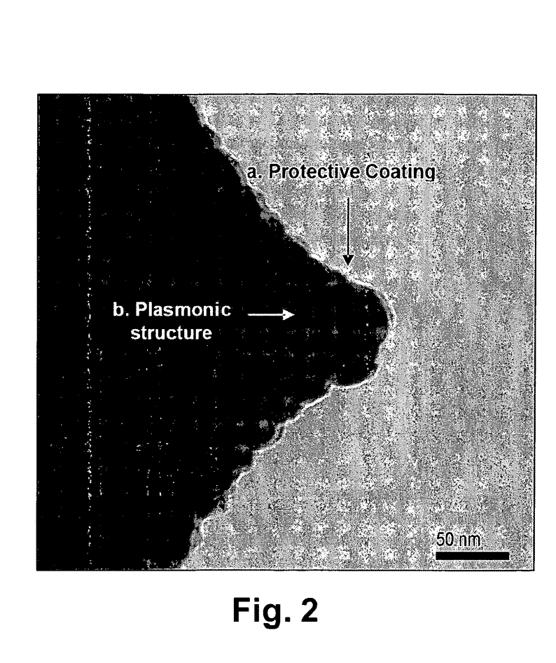

A minimal ultrathin protective coating conformally follows and completely covers the surface topography of the metallic structure to reduce attack from environmental agents or degradation due to heating from illumination. FIG. 2 is a photo of a transmission electron microcopy (TEM) image of a metallized SPM tip with a silver structure protected by SiOₓ so that the apex of the coated tip has a nominal radius of curvature between 10 nm and 25 nm. When this tip is used in TERS, a contrast factor of 1.8 is achieved (contrast is as defined below). FIG. 2 presents an image of one tip showing the thin SiOₓ coating fabricated by physical deposition on the silver plasmonic structure covers the entire plasmonic structure.

The appropriate coating for optical applications does not interfere with the optical properties of the plasmonic structure. Experiments were performed comparing the enhancement from a protected tip with that from an unprotected tip. Comparison of the signals and quantification of the phenomena central to defining the behavior of protected structures requires definition of the terms enhancement factor (EF) and contrast. These experimental figures of merit, “contrast” and “enhancement factor”, are based on comparison of the “withdraw” and “contact” signals. The “withdraw” signal is measured with the tip pulled far from the sample so that there is no enhancement from the tip. The signal observed is the far-field signal (“far”) collected from the entire area illuminated by the incident beam diameter of about 1 micron. This is an unenhanced and unlocalized signal. The “contact” signal is measured with the tip in contact with sample. In this case, there is strong enhancement in a nanoscale region about the contact with the tip. The near-field signal (“near”) from this very small region is strongly enhanced. The collected signal, however, contains both the far-field and near-field signals (I_{far}+Iₙₑₐᵣ), so the overall increase in signal seems modest. In order to calculate the actual “enhancement” of signal that occurs in the small volume under the tip one must account for the large differences in the volume of the region from which the far-field signal comes and the volume of the region from which the near-field signal comes. The enhancement factor is given by Equation (1), shown below;

EF=(Iₙₑₐᵣ/I_{far})×(V_{far}/Vₙₑₐᵣ)=((Iₜₒₜₐₗ/I_{far})−1))×(V_{far}/Vₙₑₐᵣ) (1)

where Vₙₑₐᵣ and V_{far} are the sampling volumes from which the near-field and far-field signals come. For the unprotected metallized tip the enhancement factor is at least of the order of 10,000. The ratio of this overall signal with the tip in contact to the overall signal measured with the tip withdrawn, measured for a specific wave number, is referred to as the “contrast” and is provided in Equation (2);

Contrast=(Iₙₑₐᵣ\I_{far})=((Iₜₒₜₐₗ/I_{far})−1) (2)

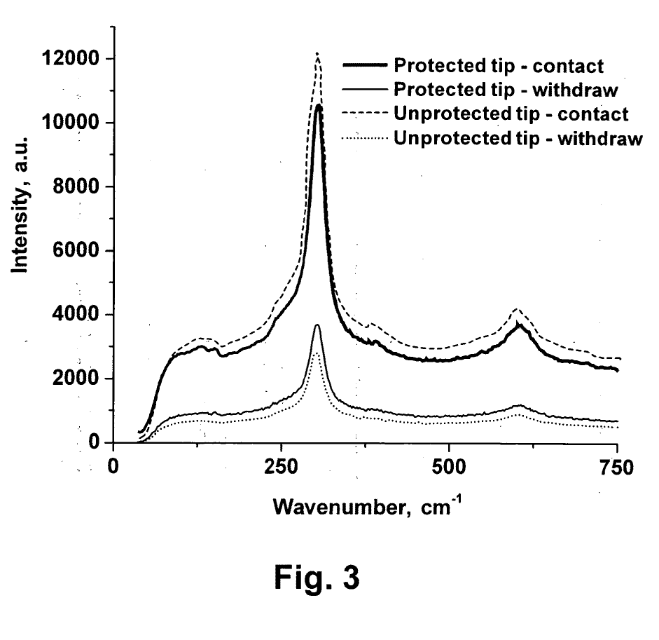

The ratios of the contrast factors of the tip with protection and tip without protection were very similar for all experiments. FIG. 3 compares the signals measured on an inorganic film made of cadmium sulfate (CdS) with an unprotected tip and a corrosion-protected tip for one batch. FIG. 3 is a graph comparing tip enhanced Raman spectra from an inorganic film made of cadmium sulfate (CdS) sample obtained with a freshly-prepared, protected, metallized tip versus those obtained with an unprotected, metallized tip from the same sample (the increase in signal from the “withdrawn” state to the “contact” state is comparable for the protected and unprotected tips).

### Preparation of the Protective Coating and Demonstration of Increased Lifetime:

The protected multilayer plasmonic structures are prepared by sequential PVD of silver and SiOₓ or Al at very low pressures (10⁻⁷ Torr). Depositions of both the metallic and dielectric layers are performed using a single conventional vacuum chamber designed for evaporation of metal and deposition onto a flat substrate. The thicknesses and morphologies of both layers are controlled by manipulating deposition rates. The deposition of silver at rates of 0.1 Angstroms/s to 0.3 Angstroms/s minimizes distortion of the cantilever. A higher deposition rate is used for the SiOₓ to minimize exposure of the tip to the temperatures required for this deposition. In the case of Al₂O₃, a deposition rate slower than 0.2 Angstroms/s is used. Other means of depositing the protective ultrathin coatings on the plasmonic structures include, but are not limited to, chemical vapor deposition (CVD), ion sputtering, or wet chemical methods.

In FIG. 3 the contact (thick lines) and withdraw (thin lines) signals from a 20 nm thick CdS film on an aluminum mirror are shown. Contact signals are collected using a silicon nitride tip metallized with silver. Measurements are made with unprotected tips (dotted line) and tips protected by SiOₓ (solid line). The measured contrast factors are 2.0 and 1.8, respectively. The thickness of the protective coating and the material (SiOₓ) characteristics make it a suitable protective coating for optical applications. FIG. 3 shows that contrast is reduced by only 10% when the protective coating is added to the tip.

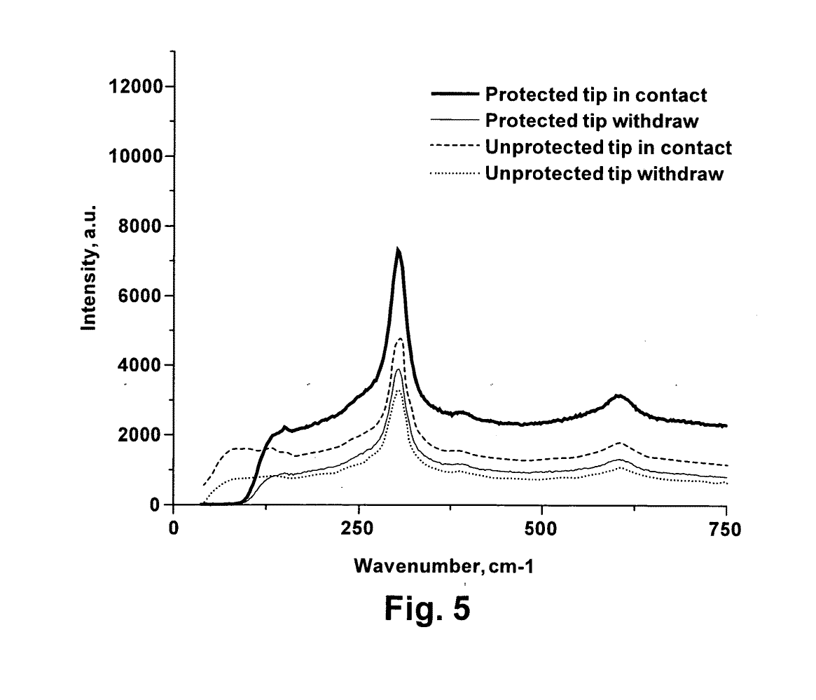

One of the main problems of unprotected silver plasmonic structures upon exposure to environmental conditions (such as, but not limited to, high humidity and the presence of sulfur agents) is a decay of the enhanced signal over time due to silver degradation. For a first set of tips (data not shown in FIG. 3) the decay of signal with time is slower with the SiOₓ protective coating present. This reduction in the rate of signal decay is documented over 21 days. Data for a tip from the second batch is shown in FIG. 5, which presents the contact (thick lines) and withdraw (thin lines) signals from a 20 nm CdS film on an aluminum mirror. Contact signals are collected using a metallized silicon nitride tip with silver without protection (dotted lines) or protected by SiOₓ (solid lines) for multiple measurements over a period of three weeks, with the tips stored under dry conditions between uses. The final contrasts are 0.4 and 0.7, respectively. Contrast decreases more over a time of three weeks for the unprotected tip than for the protected tip. After three weeks of use, with storage under dry conditions, the protected metallized tip has an enhancement 75% higher than that of the unprotected tip.

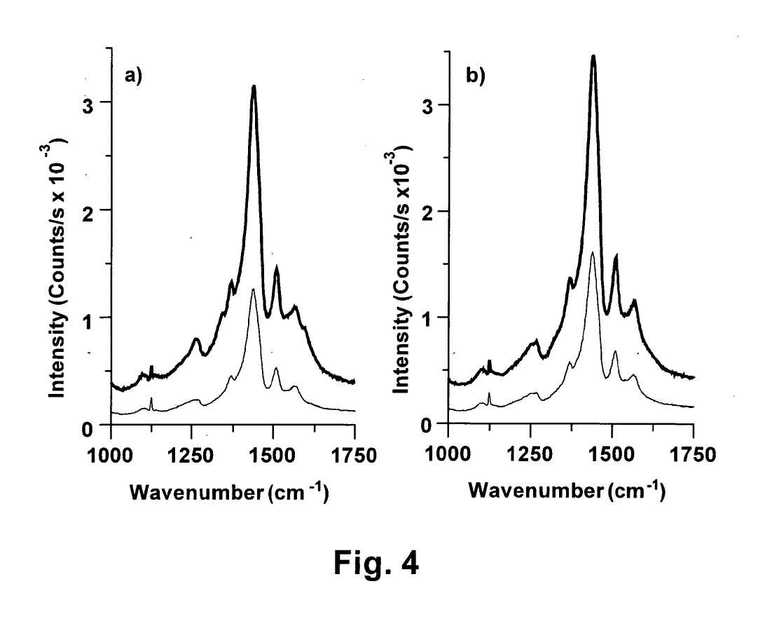

While SiOₓ ultrathin coatings extend the lifetime of silver metallized silicon nitride tips effectively under normal use conditions (1 hour exposure per day), the thickness of the layer required to essentially arrest decay in the contrast over 40 days is 10 nm. An ultrathin Al₂0₃ coating provides a superior extension to service life even while keeping the coating thickness smaller. FIG. 4 shows that the contrast remains unaffected when an ultrathin alumina coating of 2 nm thickness is added to the tip. FIG. 4 provides Raman spectra with the tip withdrawn from the sample (light curve) and with the tip in contact with the sample (dark curve) for an (a) unprotected tip and for a (b) protected tip having a 2 nm protective Al₂O₃ coating in contact with a 50 nm thick PEDOT/PSS film.

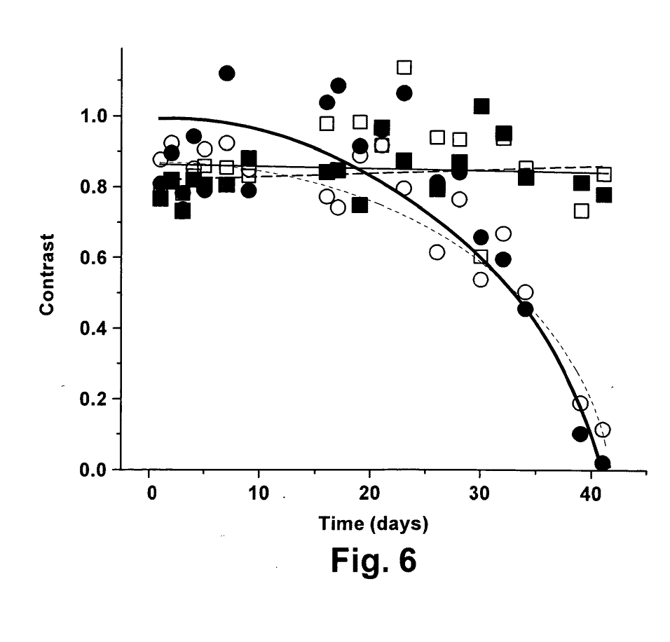

An alumina coating improves wear resistance and inhibits degradation but does not alter the favorable optical properties of metallic structures, so that signal enhancement remains constant over at least 40 days for metallized tips having an ultrathin protective coating between 1 nm and 3 nm thick. Most unprotected structures show substantial losses in enhancement over periods as short as 10 days when stored and used in ambient conditions. FIG. 6 provides a comparison of the change in contrast with time over 40 days for an unprotected tip (open circles) with that for a protected tip (filled squares) where open symbols correspond to tips stored under dry conditions (RH<10%) and filled markers correspond to tips stored under normal ambient conditions (10%<RH<60%) for the time of the experiment. FIG. 6 clearly shows how a 3 nm thick Al₂O₃ coating extends the lifetime of a metallized tip for a period of 40 days. In the case of the unprotected tip, the tip completely lost its plasmonic activity in 40 days. In FIG. 6, the open symbols correspond to tips stored under dry conditions (RH<10%) and filled markers correspond to tips stored under normal ambient conditions (10%<RH<60%) for the time of the experiment. The lifetime of the tips were effectively extended by the protection of the alumina ultrathin coating and the result is independent of storage conditions.

A literature value for the hardness of the bulk silver (Vickers hardness: Ag 251 MPa) is substantially lower than the hardness of the bare tip (Vickers hardness: Si 1415 MPa, Si₃N₄ 2040 MPa) or the alumina layer (Vickers hardness 2600 MPa) and adding the hard coating is expected to reduce wear of the silver. FIG. 7 shows transmission electron microscopy (TEM) images of an unprotected tip and a protected tip. FIG. 7 provides TEM images of an unprotected tip after use and a protected tip after use. FIG. 7 clearly shows after scanning a relatively soft polymer film only three times the metallic structure of the blunted unprotected tip has been completely removed from the apex and silver accumulated on the base about 200 nm from the apex. The integrity of the plasmonic structure seems unaffected for the Al₂O₃ protected tip even after three scans of a hard, patterned substrate.

Although the invention has been described in detail with particular reference to certain embodiments detailed herein, other embodiments can achieve the same results. Variations and modifications of the present invention will be obvious to those skilled in the art and the present invention is intended to cover in the appended claims all such modifications and equivalents.

What is claimed is:

1. A protected metallized scanning probe microscopy tip for apertureless near-field optical applications comprising:
an scanning probe microscopy tip;
a metal structure covering the surface of the scanning probe microscopy tip; and
at least one protective coating covering the metal structure.

2. The tip of claim 1, wherein the tip is designed to operate in contact mode, intermittent contact mode or a non-contact mode.

3. The tip of claim 1, wherein the metal structure is gold, silver, platinum, copper, any alloy thereof or any combination of two or more thereof.

4. The tip of claim 1, wherein the tip is designed to enhance the electric field of light for apertureless near-field optics.

5. The tip of claim 1, wherein the protective coating has a thickness in the range of about 0.1 nanometers to about 20 nanometers.

6. The tip of claim 1, wherein the protective coating has a thickness in the range of about 1 nanometers to about 5 nanometers.

7. The tip of claim 1, wherein the protective coating has a Vickers hardness at least 100% higher than the metal structure.

8. The tip of claim 1, wherein the protective layer is made of a dielectric material.

9. The tip of claim 8 wherein the dielectric material is silica, alumina, diamond like carbon coating, polymer film, or any combination of two or more thereof.

10. The tip of claim 1 wherein the coating improves wear resistance versus an unprotected tip by at least 10%.

11. The tip of claim 1 wherein the coating improves wear resistance versus an unprotected tip by at least 50%.

12. The tip of claim 1 wherein the coating improves wear resistance versus an unprotected tip by at least 75%.

13. The tip of claim 1 wherein the coating prevents the metal structure from being deformed.

14. The tip of claim 1 wherein the coating protects the tip from loss in signal enhancement for at least 30 days.

15. The tip of claim 1 wherein the coating protects the tip from loss in signal enhancement for at least 40 days.

16. The tip of claim 1, wherein the tip is designed to permit the topographical images of surfaces with a resolution of about 20 nanometers using a commercial scanning probe microscopy instrument.

17. The tip of claim 1, wherein the tip is designed to be used for apertureless near-field optical applications with side, top, or bottom illumination.

18. The tip of claim 1, wherein the tip is designed to be used in air, vacuum, other gas, or liquid environments.

19. A protected metallic tip for apertureless near-field optical applications comprising:
a metallic tip; and
at least one protective coating covering the metallic tip.

20. The tip of claim 19, wherein the tip is designed to operate in contact mode, intermittent contact mode or a non-contact mode.

21. The tip of claim 19, wherein the metallic tip is gold, silver, platinum, copper, any alloy thereof or any combination of two or more thereof.

22. The tip of claim 19, wherein the tip is designed to enhance the electric field of light for apertureless near-field optics.

23. The tip of claim 19, wherein the protective coating has a thickness in the range of about 0.1 nanometers to about 20 nanometers.

24. The tip of claim 19, wherein the protective coating has a thickness in the range of about 1 nanometer to about 5 nanometers.

25. The tip of claim 19, wherein the protective coating has a Vickers hardness at least 100% higher than the metal structure.

26. The tip of claim 19, wherein the protective coating is made of a dielectric material.

27. The tip of claim 26 wherein the dielectric material is silica, alumina, diamond like carbon coating, polymer film or any combination of two or more thereof.

28. The tip of claim 19 wherein the coating prevents the metallic tip from being deformed.

29. The tip of claim 19, wherein the tip is designed to obtain topographical images of surfaces with a resolution of about 20 nm using a commercial scanning probe microscopy (SPM) instrument.

30. The tip of claim 19, wherein the tip is designed to be used for apertureless near-field optical applications with side, top, or bottom illumination.

31. The tip of claim 19, wherein the tip is designed to be used in vacuum, air, other gas, or other liquid environments.
